(19) United States
(12) Patent Application Publication
(10) Pub. No.: US 2025/0032965 A1
(43) Pub. Date: Jan. 30, 2025

(54) MEMBRANE FRAME

(71) Applicant: MICHAEL MCCORMICK, Newry (GB)

(72) Inventor: MICHAEL MCCORMICK, Newry (GB)

(21) Appl. No.: 18/706,415

(22) PCT Filed: Dec. 6, 2022
(86) PCT No.: PCT/EP2022/084561

§ 371 Date: May 1, 2024

(30) Foreign Application Priority Data
Dec. 7, 2021 (IE) 2021/0206

(51) Int. Cl. B01D 46/00; B01D 63/08

(52) U.S. Cl. CPC B01D 46/0005; B01D 63/0822

(57) ABSTRACT

A frame for a membrane, the frame comprising a rear outer section for structural integrity of the frame, wherein the rear outer section surrounds an inner frame opening; a front inner section secured to a front of the rear outer section to form a first chamber for housing a membrane, and a section for retrieving the membrane, wherein the front inner section has a curved or angular front surface in the form of an integrally formed or separately attached skin and wherein the first chamber and the section for retrieving the membrane are at the opposite ends of the frame; a first membrane guide located within the first chamber for use in deployment of a membrane; wherein a first aperture from which the membrane may be deployed from the first membrane guide and a second aperture through which the membrane may be received are located at opposing ends of the front inner section such that, when deployed, the membrane covers the inner frame opening and the majority of the front surface; and wherein access panels are provided in the front inner section for access into the first chamber.

The present invention relates to a frame for one or more membranes, in particular to a combination of the frame and one or more membranes for use in one or more of filtration, fire prevention, prevention of the passage of fluids such as water, smoke, vapour and the like, land reclamation, prevention of coastal erosion, building fabric protection, construction of internal and external walls and/or the roof of a dwelling or other building, manufacturing pre-fabricated buildings, manufacturing of sluice tanks, manufacturing of storage enclosures or racks, shelving, electrical and IT enclosures, and manufacturing of storage tanks and trailers for the haulage industry.

### BACKGROUND TO THE INVENTION

Presently, the primary method of protection against tidal flooding, rainwater flooding or a river bursting its bank, is the positioning of sand bags, penstock plates, door barriers, etc., all of which are manually put into position and have many physical restrictions, e.g., as a consequence of their installation.

The secondary method in flood prevention is the constructing of dykes and walls to achieve perimeter protection from flood water and is often an engineering design of unsightly solutions and hugely expensive cost in materials, equipment, machinery and labour.

Coastal erosion is constant and the costs are in many differing concepts, the conventional solutions are outdated and expensive costs in materials, equipment, machinery and labour.

The reclamation of lands from the sea or the formation of new lands is a modern-day activity, the way in which this is engineered is through huge expense in the cost of materials, equipment, machinery and labour.

The marine industry is by its nature is full of hazards posed by water. Currently, if frequent inspections and preventative maintenance are not the norm, wear and tear can occur at high costs and allow the only form of protection to fail with devastating circumstances.

The construction of a building should incorporate the core values of security, warmth, insulation, dry, privacy etc. Differing materials and methods of installation have been used in the past with little or no reduction in cost or carbon footprint and questionable quality as many parties are involved in the construction, and with technology offering much more the carbon footprint and cost of construction keep growing.

In recent years, uncontrollable bush or forest fires occurred in many parts of the world, with homes and sometimes whole neighbourhoods lost, succumbing to the flames and thermal combustion of the intense heat.

Modern buildings are designed with fire prevention being an integral part of the brief. Fire alarm systems, sprinkler systems, fire doors, fire dampers, fire extinguishers are examples from the list. The cost of equipment to purchase is exacerbated by the high cost of the installation as it delivered by numerous different manufacturers or suppliers with the installation from differing disciplines.

The filtration of the air we breathe, the water we drink, the fumes and the effluent we create is commonplace and because of the growing populations, the need and the costs also grow.

The practice of the separation of liquids and solids is common and waste water treatment largely still uses the method of settlement tanks. The carbon footprint and costs are both high.

The materials used in manufacturing sluice gates and the footprint they require for operating water level change through the methodology are both outdated.

Enclosed I.T. racks or cabinets for servers that store personal data can result in the generation of hazardous heat.

The haulage industry trailer design offers only stored passage of goods with little or no fire protection of the structure or the goods in transit or security or safety features.

Pre-fabricated buildings usually offer the enclosed unit, with little or no fire protection of the building fabric or pre-installed services within and a temporary life span.

The alternative design for the construction of tanks or pools has always proved difficult, as the challenge to retaining water was immense.

It is a therefore an object of the present invention to provide an improved solution to the problem of any one of filtration, fire prevention, prevention of the passage of fluids such as water, smoke, vapour and the like, land reclamation, prevention of coastal erosion, building fabric protection, construction of internal and external walls and/or the roof of a dwelling or other building, manufacturing pre-fabricated buildings, manufacturing of sluice gates, manufacturing of storage enclosures or racks, shelving, electrical and IT enclosures, and trailers for the haulage industry, the construction of a swimming pool or tank or at least a suitable alternative thereto.

### SUMMARY OF THE INVENTION

The present invention relates to a frame for one or more membranes.

Depending on the type of membrane or membranes used with the frame, the following uses may be provided by the frame according to the invention:
raising the height of a river bank and preventing it from bursting;
prevention of tidal flooding;
protecting the building fabric of a property from water ingress;
waterproof sealing for a doorway, gateway, vent, or window or other opening;
waterproofing of structures in the process of land reclamation and coastal erosion;
the construction of walls and/or roofs, giving a thermal protective, insulated, waterproof acoustic barrier;
providing thermal insulation, thermal and fire protection and/or waterproofing/weathering to the exterior of a roof or building;
purification, conditioning and renewed multi-use filtration of water;
treatment, conditioning and renewed multi-use filtration of other liquids and effluent;
conditioning and renewed multi-use and filtration of air and exhaust fumes;
multi-deck, multi-use gravitational separation of water and sediment;
separation of solids and particles;
fire prevention and fire suppression in a room or enclosure;
manufacturing of storage enclosures, shelving and IT enclosures to provide a fire suppressing frame and a secure and fire protective membrane with automatic activation of each feature;
manufacturing of haulage trailers to provide a fire suppressing, direct ventilation frame and secure, fire protective curtain sides with automatic activation of each feature;
in the construction of pre-fabricated buildings for the direct ventilation of rooms and enclosures; and
manufacturing/construction of tanks, pre-fabricated tanks and swimming pools.

Accordingly, a first aspect of the present invention is a frame for a membrane, the frame comprising
a rear outer section for structural integrity of the frame, wherein the rear outer section surrounds an inner frame opening;
a front inner section secured to the front of the rear outer section to form a first chamber for housing a membrane, and a section for retrieving the membrane, wherein the front inner section has a curved or angular front surface in the form of an integrally formed or separately attached skin and wherein the first chamber and the retrieval section are at the opposite ends of the frame;
a first membrane guide located within the first chamber for use in deployment of a membrane;
wherein a first aperture from which the membrane may be deployed from the first membrane guide and a second aperture through which the membrane may be received are located at opposing ends of the front inner section such that, when deployed, the membrane covers the inner frame opening and the majority of the front surface; and
wherein access panels are provided in the front inner section for access into the first chamber.

When a membrane is deployed from the guide via the aperture, the membrane creates a seal upon the front surface of the frame, preferably a watertight seal which prevents water from passing through the inner frame opening. The curvature or angulation of the skin of the front inner section of the frame and the resulting tightness of the membrane upon it, seals the membrane to the frame.

In a preferred embodiment, the frame comprises
a rear outer section for structural integrity of the frame, wherein the rear outer section surrounds an inner frame opening;
a front inner section secured to the front of the rear outer section to form a first chamber for housing a membrane, a second chamber for retrieving the membrane and a third chamber between the first and second chambers and surrounding the inner frame opening, wherein the front inner section has a curved or angular front surface in the form of an integrally formed or separately attached skin and wherein the first and second chambers are at the opposite ends of the frame;
a first membrane guide located within the first chamber for use in deployment of a membrane;
a second membrane guide within the second chamber for use in retrieval of the membrane;
wherein a first aperture from which the membrane may be deployed from the first membrane guide and a second aperture through which the membrane may be received for retrieval onto the second membrane guide are located at opposing ends of the front inner section such that, when deployed, the membrane covers the inner frame opening and the majority of the front surface; and
wherein access panels are provided in the front inner section for access into one or more of the first, second and third chambers.

In a preferred embodiment, the back of the rear outer section is flat, particularly preferably wherein the rear outer section comprises a U-shape, square or rectangular flat back plate and a box section or side perimeter walls.

The inner frame opening is preferably in the centre of the frame and is either the area to be protected by a membrane or is the area of filtration, or both.

The rear outer section and front inner section are preferably integrally formed. Alternatively, the front inner section is separately formed and subsequently secured to the rear outer section.

The skin is preferably attached to the front inner section with the use of screws or cement.

The back of the skin is preferably provided with rubber gaskets to ensure the sealing upon the inner chamber walls against the back of the front surface and from each other.

The first and second chambers are preferably secured to the back plate or, alternatively, fabricated in place and sealed.

The first and second chambers are isolated from each other by the third chamber.

The inner walls of the third chamber make up the walls of the inner opening of the frame, thus preventing the passage of smoke or water through the internal structure of the frame when the frame is completely assembled.

In a preferred embodiment, one or more walls of the third chamber comprise one or more of a ledge protruding into the inner opening of the frame, a picture frame feature upon which a door can rest, a cooling coil for use in the de-humidification of air, UV lamps for the disinfectant of water and air, electromagnetic coils and electrodes to energise and manipulate ions in water for the propulsion of water and or the conditioning of water, damper blades for the control of air velocities, and a grid or mesh for support of the membrane and which covers the area being protected or for filtration.

In a preferred embodiment, the access panels for the first and second chambers are located in the skin, i.e., front surface, of the front inner section, particularly preferably at opposing ends of the skin.

In an alternative preferred embodiment, the access panels for the first and second chambers are located at the rear of the back of the frame.

In a preferred embodiment, the access panel for the third chamber is provided adjacent the inner frame opening.

In a preferred embodiment, the membrane guides each independently comprise one or more selected from among a guide roller, a guide bar and a guide rod.

A membrane deployment bar or rod is preferably mechanically linked to the first membrane guide with the use of a pulley or chain linked system.

In a preferred embodiment, the first membrane guide comprises a membrane deployment bar and a membrane deployment guide roller located within the first chamber for use in deployment of the membrane, preferably wherein the membrane deployment bar and membrane deployment guide roller are mechanically linked.

In a preferred embodiment, the second membrane guide comprises a membrane retrieval rotating rod and a membrane retrieval guide roller located within the second chamber for use in retrieval of the membrane preferably wherein the membrane retrieval rotating rod and membrane retrieval guide roller are mechanically linked.

Membrane deployment may be activated manually or automatically. In a preferred embodiment, an external actuator is placed on the outside of the rear outer section, particularly preferably adjacent the second chamber, i.e., adjacent the chamber for retrieval of the membrane, for activation of membrane deployment, e.g., wherein the actuator is attached to the membrane retrieval bar.

Alternatively, an internal actuator is placed within the second chamber and actuation is enabled with the use of a pulley or chain linked system connected to the second membrane guide, e.g., to a membrane retrieval bar.

In a preferred embodiment, the frame comprises an internal frame ventilation system, such as a fan.

In a preferred embodiment, one or more internal fans are located within the third chamber formed by the front inner section and rear outer section, preferably wherein the front inner section or the rear outer section, or both, comprise apertures such as perforations or slots for ventilation.

In the embodiment with apertures on both the front inner section or the rear outer section, a ventilation circuit from front to back is active when the internal frame fans are energized and generate a vacuum and draw the membrane onto the front surface, creating a seal between the membrane and the frame.

Alternatively, one or more fans are located at the rear outer section and the front inner section or the rear outer section, or both, comprise apertures such as perforations or slots for ventilation. In this embodiment, the ventilation circuit is active if the external extract ventilation system creates a sufficiently strong enough vacuum to create the seal between the membrane and frame or with the use of internal fans located in the third chamber.

In a further alternative embodiment, the front inner section or the rear outer section, or both, comprise apertures such as perforations or slots but no fans are present.

A vacuum on the membrane at the gaps between the frame and a door on which it is fixed will occur when oxygen is consumed by flames and the membrane is drawn into this gap to create a seal, so the slots can be independent from the fans in this use.

In a preferred embodiment, the internal structure of the frame, i.e., the first, second and third chambers are segregated from one another for complete internal, same side of frame isolation.

The first and second chambers are sealed through the fabrication process and isolated from the third chamber, i.e., from the internal area of the frame, thus preventing the passage of smoke or water through the internal structure of the frame when the frame is completely assembled.

In a preferred embodiment, each side of the frame comprises internal mechanical apparatus for housing and retaining the first membrane for deployment.

In a preferred embodiment, the frame further comprises mechanical piping installed within the third chamber and spray points for use with one or more of a fire suppression or sprinkler system, a filtration area backwash or blow off system, a chemical dosing for conditioning of water or effluent, or the aeration of effluents or decontamination or humidification of air. The spray points are preferably located on one or more of the front surface of the front inner section, the back of the frame at the rear of the third chamber and the walls of the third chamber collar wall. In a particularly preferred embodiment, the third chamber houses a primed tank of fire suppressant connected to the mechanical piping.

In a preferred embodiment, the first chamber comprises one or more bars or rods for housing and retaining a membrane in position.

In a particularly preferred embodiment, the first chamber comprises a first membrane guide roller or a first membrane guide bar, or both, and a roll or cartridge of membrane which is held in position with the use of the first membrane securing bar or rod, wherein the first membrane is pre-deployed via the first membrane guide roller and/or the first membrane guide bar and passed through the first membrane deployment aperture on the skin of the frame above the first chamber and across the surface of the frame, where it is passed through the first membrane retrieval aperture on the skin of the frame above the second chamber at the opposite side. In this embodiment, the second chamber comprises a first membrane retrieval guide roller and/or a first membrane retrieval guide bar and a first membrane retrieval rotating bar or rod, wherein the first membrane is attached to the first membrane retrieval rotating bar or rod via the first membrane guide roller and/or the first membrane guide bar and is actuated in a clockwise or anti-clockwise direction, from a point of actuation external to the second chamber or, with the use of pulley or chain linked system from an internal point of actuation in the second chamber to further retrieve the membrane across the surface of the frame.

The frame is preferably suitable for two membranes. In this embodiment, the first chamber comprises two membrane deployment guides, one above the other, and the second chamber comprises two membrane retrieval guides, one above the other.

However, this is not considered to be limiting and the frame according to the invention may be adapted for more than two membranes or comprise further chambers, or both.

In a preferred embodiment, the front inner section and rear outer section together form five chambers, the five chambers including two adjacent chambers for housing a membrane and two opposing chambers for retrieving the membrane and opposing the housing chambers, with a fifth chamber located between opposing housing chambers and retrieval chambers. In this embodiment, for a frame for two membranes, each housing chamber has one membrane deployment guide and each retrieval chamber has one membrane retrieval guide, whereas for a frame with four membranes, each housing chamber has two membrane deployment guides and each retrieval chamber has two membrane retrieval guide, and so on for further membranes.

Each membrane independently is preferably pre-deployed or readied to deploy with the use of membrane deployment/retrieval lines. In this embodiment, membrane deployment/retrieval lines are preferably passed through dedicated retrieval holes in the second chamber to the rear of the frame point of actuation via the first membrane guide roller for external rear of frame actuation.

Each membrane is preferably deployed singularly. Alternatively, the membranes may be deployed simultaneously.

In a preferred embodiment, the membrane deployment action is spring-return.

In a preferred embodiment, the skin comprises electrodes for electrification of the membrane.

A further aspect of the present invention is a frame and a membrane in combination, wherein the frame is as described hereinbefore and the membrane is housed within the frame, wherein the membrane comprises a thin, pliable, flexible, robust sheet of material.

In a preferred embodiment, the membrane is manually attached to the frame with laths.

The membrane may be for a specific single purpose or multi-purpose.

In a preferred embodiment, the membrane comprises a porous or permeable surface. Alternatively, the membrane is impermeable. The membrane is preferably one or more of fire-retardant, thermally insulating and thermally protective. In a preferred embodiment, the membrane is a microbiological membrane. Alternatively, or additionally, the membrane preferably comprises one or more of metallic mesh, foil, lead, PVC, or polyester canvas.

The membrane is deployed via the slot in the surface of the frame, over the surface of the frame and retrieved at the opposite side, either via holes in the frame or a slot on the surface to give a waterproof seal over the surface of the frame and across the inner frame opening.

In a preferred embodiment, the membrane is multi-layered product for varying purposes.

In a preferred embodiment, the membrane further comprises retrieval lines embedded or embodied in each side thereof.

Preferably, the membrane further comprises one or more slots for one or more of doors, windows, chimney, exhaust openings or vents.

Preferably, the outer surface of the membrane further comprises a mesh or grill or supports across the inner frame opening, particularly preferably a load bearing mesh or a grill of structured design.

Preferably, the outer of the membrane is decorative.

The membrane is of any suitable shape for deployment through the apertures and to cover the front of the frame, e.g., square or rectangular.

The frame and membrane according to the invention are suitable for providing thermal protection to the fabric it is placed in front of and it can give waterproofing.

The frame and membrane according to the invention may thus also be used for the prevention of fire; the filtration of water, liquids and effluents; the filtration of air and fumes; the separation of solid particles; land reclamation; the prevention of coastal erosion; and building fabric protection.

The frame and membrane according to the invention may employed in the construction of internal and external walls of a dwelling or other building; the construction of a roof of a dwelling or other building; in pre-fabricated buildings; in storage enclosures or racks, shelving, electrical or IT enclosures; and for trailers for the haulage industry.

In a preferred embodiment, the frame may further comprise a cover for mechanical protection of the membrane.

The cover is not essential in the process of the membrane being deployed over the frame, however, if present, the cover provides mechanical protection to the edges of the membrane.

The cover further provides a structure for additional features such as a brush which could remove debris from the membrane surface as it passed through the deployment/retrieval motion. The cover preferably comprises a raised area, such as a rib, along the full width and same on the frame to squeeze a membrane between and remove water.

In a preferred embodiment there is a load bearing structure in the inner opening of the frame which is being protected by the membrane and for the membrane to lie upon, like a door or window or alternatively the area for filtration has a grill or grid to give support for the membrane.

In a preferred embodiment, the frame may house two or more membranes. These membranes may have the same or differing properties to each other, for example they may have the same or different micron value. The frame may for example house two membranes for a double seal, or for a dual function of a more robust outer layer across the inner frame opening, e.g., giving an impermeable barrier, thermal protection, and/or a protective acoustic barrier across the inner frame opening. Preferably, the frame houses several membranes of differing properties to give a secure, impermeable, thermal protective, insulated, acoustic structure across the surface of the frame and its inner opening.

In a preferred embodiment, multiple units, i.e., two or more frames and associated membrane(s), are adjoined and installed in a side-by-side arrangement, particularly preferably upon foundations of calculated strength to withstand necessary weights of pressure from water or in front of a porous, load bearing structure or alternatively, the frame and membrane(s) may form an integral part of an impermeable wall when installed between load bearing pillars.

In a preferred embodiment, two units, i.e., two frames and associated membrane(s), are adjoined and installed in a back-to-back arrangement, giving a thermal and air tight seal either side of the inner frame opening or the same protection either side of the inner frame opening or providing a double-sided filtration frame that may have a common filtered product draw-off point from the inner frame opening. In this embodiment there is preferably a void between each unit additional to their inner frame opening. Additionally, or alternatively, the back-to-back arrangement further comprises an extension collar.

In a preferred embodiment, four units, i.e., two frames and associated membrane(s), are adjoined and installed to form a six-sided structure (a cube or cuboid), wherein the four units are adjacently attached along their outer edge at a right angle to one another with a solid floor and a roof, preferably wherein each frame which makes up a vertical face of the structure has an accessible inner opening or one side may be of a solid face.

The frame preferably further comprises installed pipe work for the use as a fire suppression or sprinkler system, particularly preferably wherein two of the frame sides have the fire suppression or sprinkler system and two sides have internal segregation and vents on the inner frame surface, for the use as a method of direct ventilation within said frame.

Preferably, the membrane housed within the frame provides walls and provides a secure, thermally protected air tight protective surface.

Preferably, the frame further comprises structured or designed shelving or slotted entries for the specific needs of housing IT servers and/or electrical equipment.

In a preferred embodiment, the frame is installed in a multi-deck design within an enclosure, wherein within each deck a membrane for the use of filtration is housed, each membrane being of a differing micron value, with the most permeable membrane at the upper deck. Preferably, a filtered product draw-off point is provided for each level of the deck.

In a preferred embodiment, the frame is installed in a side-by-side design within a channel and hinged at the top and bottom of the outer sides of the channel, wherein each membrane frame is a sluice gate and a deployed membrane is a controlled water weir.

In one embodiment, a structure of six sides (a cube or cuboid), the four sides adjacent and attached along the outer edge at a right angle to one another is formed from multiple frames according to the invention with a solid floor and roof.

Within each frame of the six-sided structure, pipe work is preferably installed for the use as a fire suppression system, particularly preferably with internal segregation and vents on the inner frame surface, for the use as a method of direct ventilation to within the structure.

The membrane housed within the frame preferably provides walls including a secure, thermally protected air tight outer wall. In this embodiment, the frame preferably further comprises structured or designed shelving for the use as a secure fire protected electrical or IT servers' enclosure, for the use as secure fire protected storage, for the use as a secure fire protected enclosure.

In a preferred embodiment, four units, i.e., two frames and associated membrane(s), are adjoined and installed to form a six-sided structure (a cube or cuboid), wherein the four units are adjacently attached along their outer edge at a right angle to one another with a solid floor and a roof, preferably wherein pipe work is installed for the use as a wash or blow off system, and wherein the membrane covers the surface of the frame and provides a multi-change filtration surface, with the inner area of the cube or cuboid being a common filtration zone.

Alternatively, pipe work is installed for the use as a fire suppression system, with internal segregation and vents on the inner frame surface, for the use as a method of direct ventilation to within the structure, wherein the membrane housed within the frame provides walls including a secure, thermally protected air tight outer wall, for the use as a secure and fire protected haulage trailer.

Alternatively, or additionally, cabling and piping are provided within the frame for electrical and mechanical services, wherein the membrane attached to the frame provides the buildings' fabric of a secure, thermally protected, insulated and acoustic outer wall, for the use as a pre-fabricated building or dwelling.

Alternatively, or additionally, each internal face of the wall has a membrane permanently attached to provide a water tight seal for the perimeter walls of a tank.

Preferably, a brush is affixed to the underside of the frame cover to provide a cleaning motion across the surface of the membrane as it is deployed.

### BRIEF DESCRIPTION OF THE DRAWINGS

Certain preferred embodiments of the present invention will now be described, by way of example only, with reference to the accompanying drawings in which:

FIG. 1 shows a perspective view of a preferred frame according to the invention;

FIG. 2 shows a perspective view of a preferred frame and membrane according to the invention;

FIG. 3a shows a plan view of the preferred frame according to FIG. 2;

FIGS. 3b and 3c show side and end views of the frame of FIG. 3a, respectively;

FIG. 4a shows a cross-sectional side views of the frame of FIGS. 2 and 3;

FIG. 4b shows a cross-sectional side views of an alternative preferred frame according to the invention;

FIG. 5 shows an internal perspective view of the frame of FIG. 2;

FIGS. 6 shows a partial perspective view of the internal mechanics of the frame of FIG. 2;

FIG. 7 shows a partial perspective view of alternative internal mechanics for use with the frame according to the invention;

FIG. 8 shows a perspective view of the frame of FIG. 2 including optional extra features;

FIGS. 9a and 9b show side views of the frame of FIG. 8;

FIG. 10 shows a perspective view of two frames of FIG. 2 connected with an extension collar;

FIG. 11 shows a partial isometric view of the frames of FIG. 10;

FIG. 12 shows a partial isometric view of the frames of FIG. 10;

FIG. 13 shows a perspective view of a cuboid structure formed from frames of FIG. 2;

FIG. 14 shows a perspective view of an alternative preferred frame according to the invention;

FIGS. 15a and 15b show a plan view and a side view of the frame of FIG. 14;

FIGS. 15c and 15d show a plan view and a side view of another alternative preferred frame according to the invention;

FIG. 16 shows a perspective view of an alternative back-to-back design of two frames of FIG. 2;

FIG. 17 shows a cross section side view of the back-to-back design of FIG. 16;

FIG. 18 shows a plan view of the back-to-back frame design of FIG. 16;

FIGS. 19a, 19b and 19c show front, side and plan views of a preferred membrane for use with a frame according to the invention;

FIGS. 20a and 20b show perspective views of an alternative preferred membrane for use with a frame according to the invention;

FIG. 21 shows a perspective view of a preferred frame membrane cassette according to the invention;

FIG. 22 shows a partial perspective view of the upper section of the frame of FIG. 2;

FIG. 23 shows an alternate partial perspective view of the frame of FIG. 2;

FIG. 24 shows a plan view of the frame of FIG. 23;

FIG. 25 shows a front view of the frame of FIG. 23;

FIG. 26 shows a partial perspective view of a preferred frame cover according to the invention;

FIG. 27 shows a partial perspective reverse view of the frame cover of FIG. 26;

FIG. 28 shows an internal perspective view of the frame of FIG. 14;

FIG. 29 shows an isometric view of another alternative preferred frame according to the invention;

FIGS. 30 shows a partial perspective view of the internal mechanics of the frame of FIG. 2;

FIG. 31 shows a perspective view of the reverse of the frame skin of the frame of FIG. 1;

FIG. 32 shows a side view of the frame of FIG. 1 in an enclosure;

FIG. 33 shows a perspective view of two frames of FIG. 1 side by side; and

FIG. 34 shows an alternative cross section side view of the back-to-back design of FIG. 16.

### DETAILED DESCRIPTION

Various embodiments of the present invention will be described in detail with reference to the drawings, where like reference numerals represent like parts and assemblies throughout the several views.

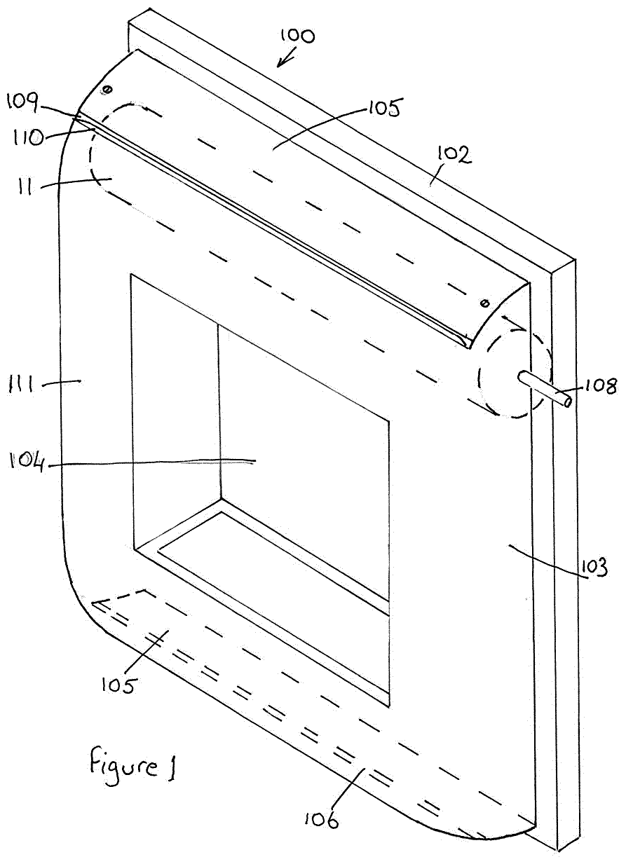

Referring to the drawings, FIG. 1 shows a preferred membrane frame according to the invention, generally referred to by reference numeral 100 and having a top end 190 and bottom end 191.

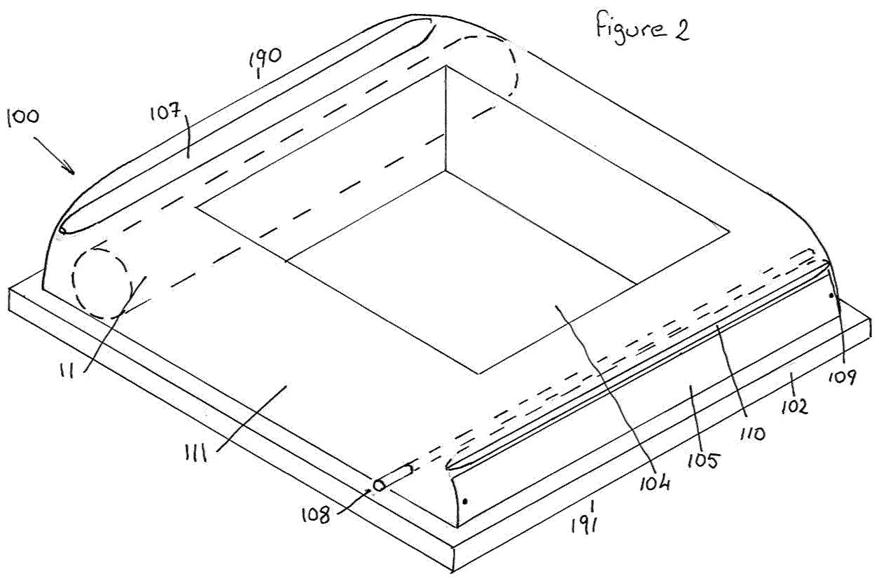

As shown in FIGS. 1 to 5, frame 100 has a rectangular rear outer section 102 for structural integrity of frame 100 and surrounding an inner frame opening 104, a front inner section 103 secured to the front of outer section 102 to form first and second chambers 132, 133 for housing and retrieving a first membrane 11, respectively, and third chamber 134 between chambers 132 and 133.

Front inner section 103 has a curved front surface 111 surrounding inner frame opening 104 and comprising access panels 105 for access into chambers 132 and 133. However, this is not considered to be limiting and front surface 111 of front inner section 103 may be angular instead of curved. Front surface 111 is preferably made of steel plate, aluminium sheet, hardened plastic, carbon fibre or fibre glass. However, this list is not exhaustive.

Frame 100 further comprises first membrane guide roller 107 located within chamber 132 at top end 190 of frame 100 for use in deployment of first membrane 11 and a second membrane guide roller 110 within chamber 133 at bottom end 191, i.e., at the opposite end of frame 100, for use in retrieval of membrane 11.

Membrane 11 is housed within chamber 132 in rolled up form or as a cassette and is deployed via membrane deployment aperture 106 with the use of membrane deployment guide roller 107 and retrieved through membrane retrieval aperture 109.

Chambers 132, 133 are sealed through the fabrication process and isolated from chamber 134, i.e., from the internal area of the frame, thus preventing the passage of smoke or water through the internal structure of the frame when the frame is completely assembled.

First membrane 11 is attached to membrane retrieval bar 124 and directly actuated at 108 such that membrane 11 may be rolled up upon membrane retrieval bar 124. When deployed, first membrane 11 passes over second membrane guide roller 110, covers inner frame opening 104 and the majority of front surface 111 and provides a seal.

In FIGS. 1 to 5, first aperture 106 from which first membrane 11 may be deployed from first membrane guide roller 107 is located on front surface 111 at top end 190 and second aperture 109 for retrieval of membrane 11 is located at bottom end 191 such that, when deployed, membrane 11 covers inner frame opening 104 and the majority of front surface 111. However, this is not considered to be limiting and deployment aperture 106 may instead be at bottom end 191 with retrieval aperture 109 at top end 190.

Front inner section 103 is preferably permanently attached to rear outer section 102 with front surface 111 forming an impermeable load bearing structure. For example, front surface 111 of front inner section 103 may be to welded to rear outer section 102 or attached using cemented joints.

In a preferred embodiment, not shown in the Figures, front surface 111 sits into a slotted groove (not shown) on rear outer section 102 where it is retained in position with the use of countersunk screws, cements or welded. A gasket feature may be provided in the groove to give an enhanced sealed fixing.

In another preferred embodiment, not shown in the Figures, the reverse surface of front surface 111 has a slotted groove where it is retained in position with the use of resin, glue or the like. A gasket feature is preferably provided in the groove to give an enhanced sealed fixing. Alternatively, a gasket feature is preferably used to provide the base for the walls of internal chambers 132, 133, 134 to sit upon.

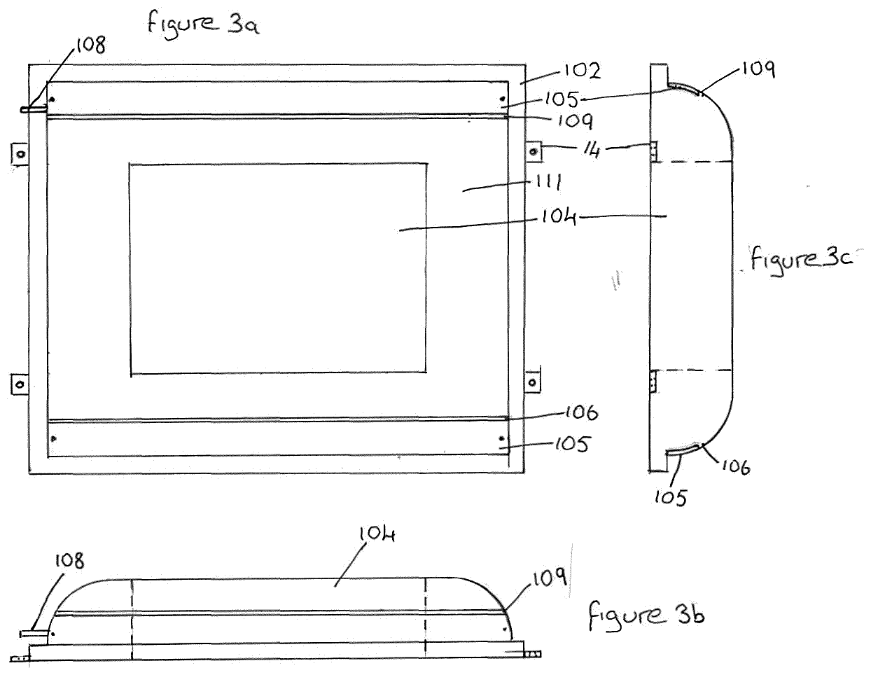

FIG. 3b shows that aperture 109 for the retrieval of membrane 11 is wider than inner frame opening 104 and when actuated at 108, deployed membrane 11 covers the whole of inner opening 104 and creates a seal upon front surface 111.

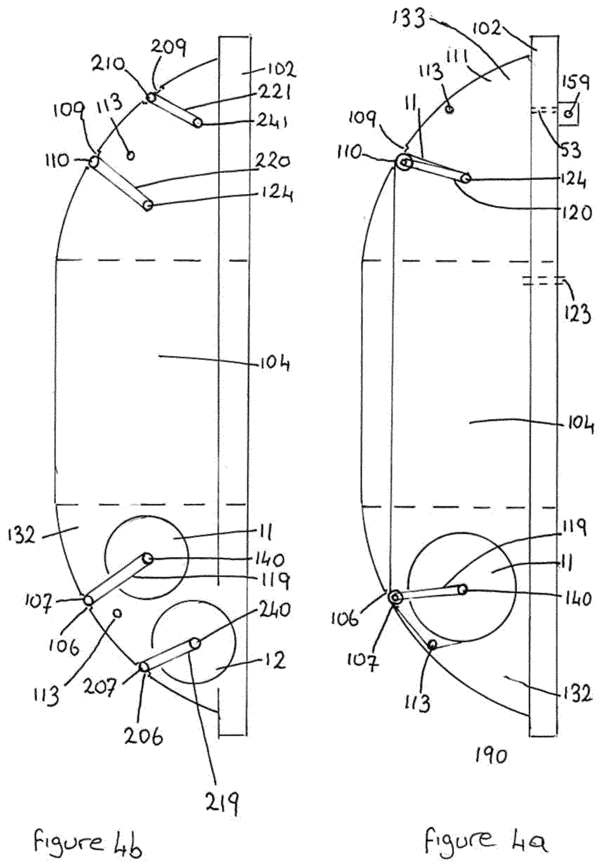

FIG. 4a shows a roll of membrane 11 housed within the internal frame structure of frame 100. Membrane 11 is deployed via aperture 106, over deployment guide roller 107 and retrieved via aperture 109 over retrieval guide roller 110 where it is attached to membrane retrieval bar 124. To promote a seamless deployment/retrieval actuation, pulley wheel or cog mechanical linkage 119 is preferably located between membrane retention bar 140 and deployment guide roller 107. A further pulley wheel or cog mechanical linkage 120 is located between membrane retrieval bar 124 and membrane retrieval guide roller 110.

Membrane 11 is fed around membrane guide bars 113 to achieve the most suitable angle for deployment. The retrieval of membrane 11 preferably occurs via actuator 108, external to frame 100, or alternatively with the use of retrieval point 159 located at the back of frame 100, where retrieval lines 47 of the membrane 11 are actuated through aperture 53. Each of actuator 108 and retrieval point 159 may be manually or automatically activated. Membrane deployment action is preferably a mechanical spring return action.

In the preferred embodiment shown in FIG. 4a, rear outer section 102 is provided with drainage pipe 123 adjacent inner frame opening 104. Drainage pipe 123 is for the draining of product which has passed through the area of filtration when there is no passage through the back of frame 100 via inner opening 104.

FIG. 4b shows an internal side view of a preferred alternative membrane frame 200 according to the invention, generally referred to by reference numeral 200 and being for two membranes. Frame 200 differs from frame 100 in that it comprises a third aperture 206 for deployment of a second membrane 12 and fourth aperture 209 for retrieval of membrane 12.

In frame 200, two rolls of membrane 11, 12 are housed within chamber 132. Membrane 11 is deployed and retrieved as previously described above and membrane 12 is deployed via aperture 206 using deployment guide roller 207. As shown in FIG. 4b, there is a pulley wheel or cog mechanical linkage 219 located between membrane retention bar 240 and deployment guide roller 207. The retrieval of membrane 12 occurs via aperture 209 with the use of a direct actuation point (not shown). Membrane 12 is fed over membrane guide roller 210 and is attached to membrane retrieval bar 241 onto which it is wound. Due to the angle for the points of deployment and retrieval of membrane 12, apertures 206, 209 are further to the back of frame 200 and may be wider than apertures 106, 109 for the deployment of membrane 11 and therefore the surface area of frame 200 covered by membrane 12 is greater than that covered by membrane 11.

In an alternative embodiment, not shown in the Figures, apertures 106 and 109 are wider than apertures 206 and 209 such that the surface area of frame 200 covered by membrane 11 is greater than that covered by membrane 12 regardless of the aperture position on the frame.

FIGS. 4a, 4b and 4c show fixing points 14 which may be used to secure the Frame in position.

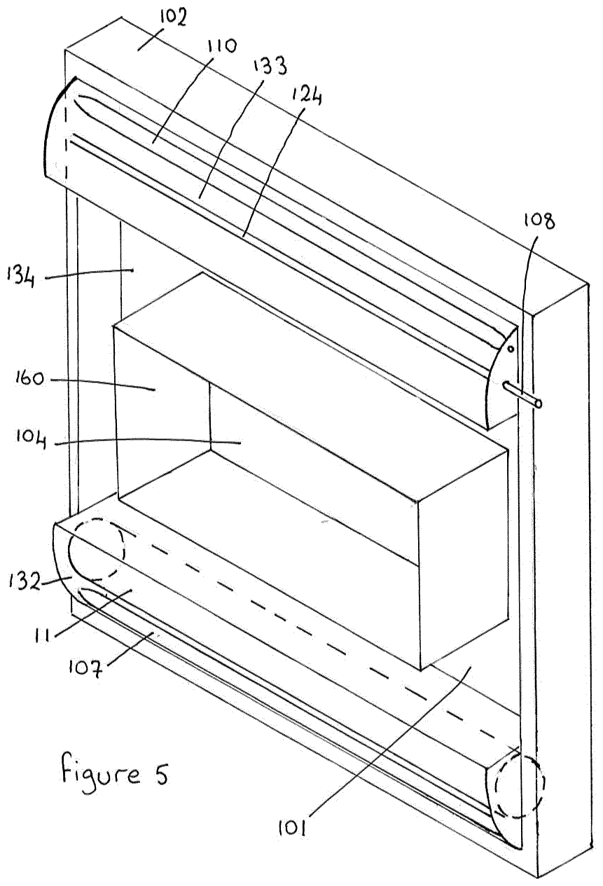

FIG. 5 shows frame 100 with front surface 111 removed. As can be seen in this Figure, membrane 11 is housed within chamber 132. Chamber 132 is sealed such that air and water may not pass. Membrane 11 is preferably pre-loaded and readied for deployment, with membrane retrieval lines 47 or membrane 11 itself, fed around the back of membrane deployment guide roller 107 and through aperture 106 (not visible in FIG. 5). Membrane retrieval lines 47 or membrane 11 are then fed through membrane retrieval aperture 109 (not visible in FIG. 5) and around the back of membrane retrieval guide roller 110 and attached to membrane retrieval bar 124 which in this case is attached to actuator 108. Actuator 108 is external to frame 100 in the embodiment shown in FIG. 5. Chamber 133 for the housing of the retrieved membrane is also a sealed section through which air or water shall not pass through.

As shown in FIG. 5, inner frame opening 104 is surrounded by four-sided collar wall 160 of chamber 134, through which direct ventilation can occur. Fire suppression services or aeration or air and water conditioning services (not shown) may be installed in chamber 134.

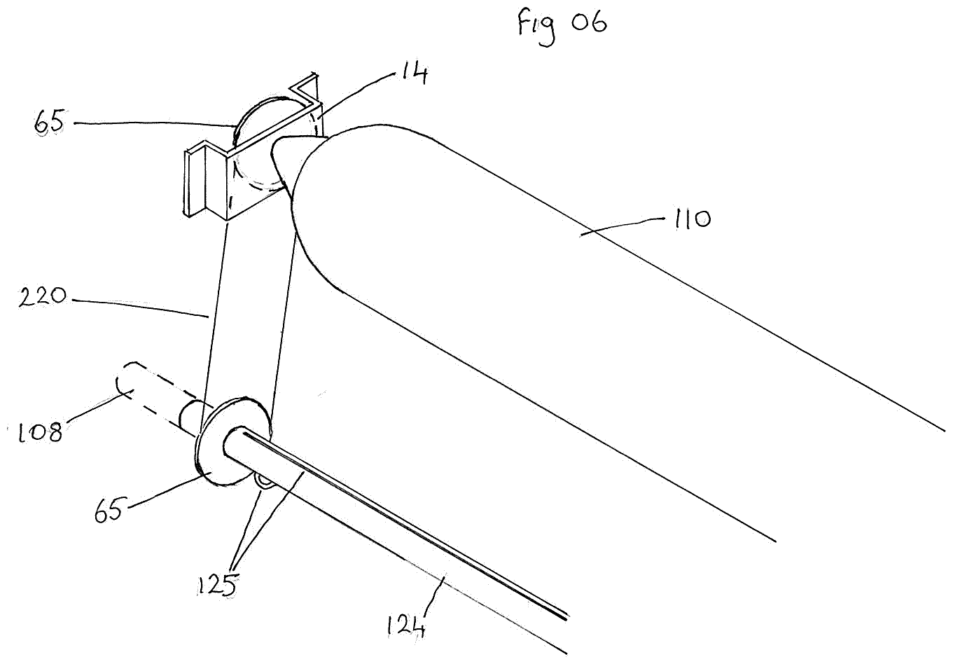

FIG. 6 shows membrane retrieval guide roller 110 and membrane retrieval bar 124 attached to actuator 108, wherein actuator 108 is external to the wall of chamber 133. Mechanical linkage 220 uses pulley wheels 65 to connect membrane retrieval guide roller 110 and membrane retrieval bar 124 to promote ease of membrane retrieval. Membrane 11 is preferably passed through membrane retrieval aperture 109 (not shown in FIG. 6) over membrane retrieval guide roller 110 and attached to bar 124 at securing points 125 or via membrane retrieval lines 47. Mounting brackets 14 are preferably used for installation.

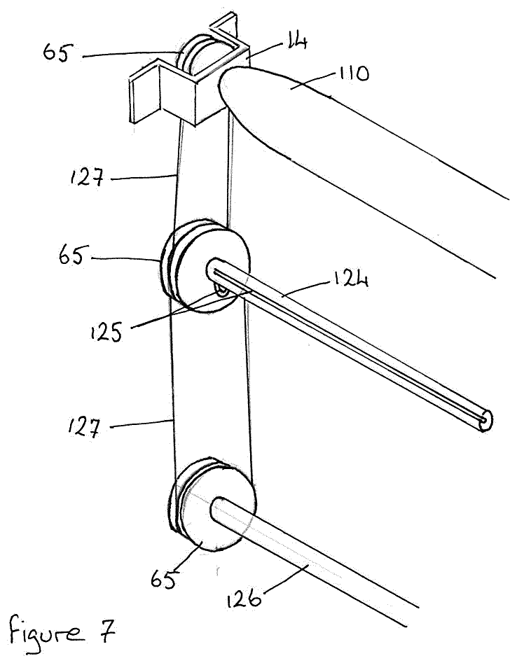

FIG. 7 shows an alternative embodiment to that shown in FIG. 6, in which an indirect actuation can occur within chamber 133. In this embodiment, the point of actuation is bar 126 and with the use of pulley wheels 65 and mechanical linkage 127, the actuation of membrane retrieval bar 124 occurs. There is a further mechanical linkage between the membrane guide roller 110 and the membrane retrieval bar 124 to promote a seamless deployment/retrieval actuation. Membrane 11 is retrieved through the aperture 109 (not shown in FIG. 7) and over membrane retrieval guide roller 110 when bar 126 is rotated in a clockwise direction.

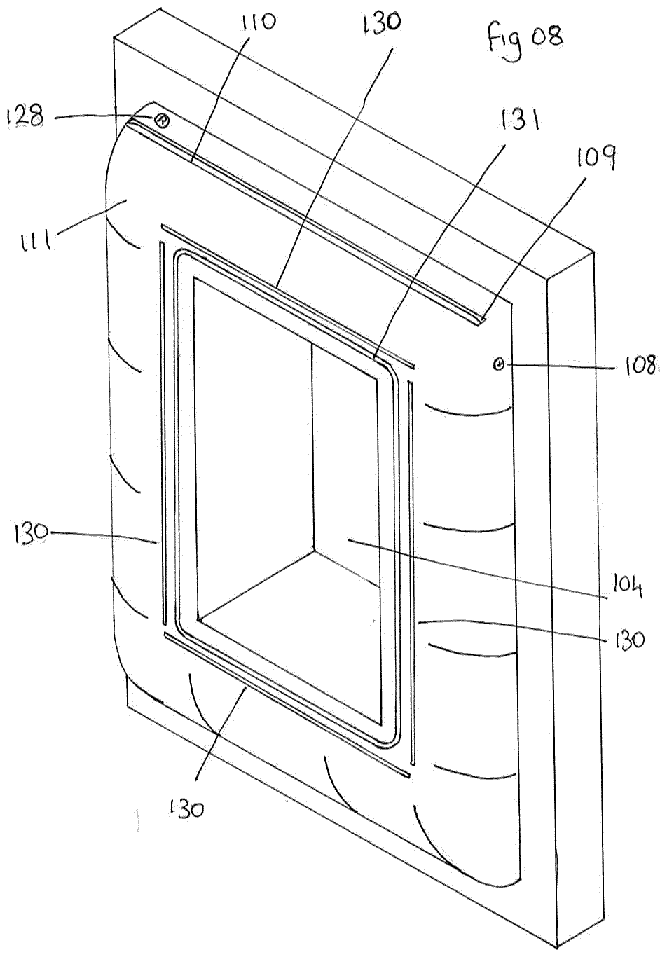

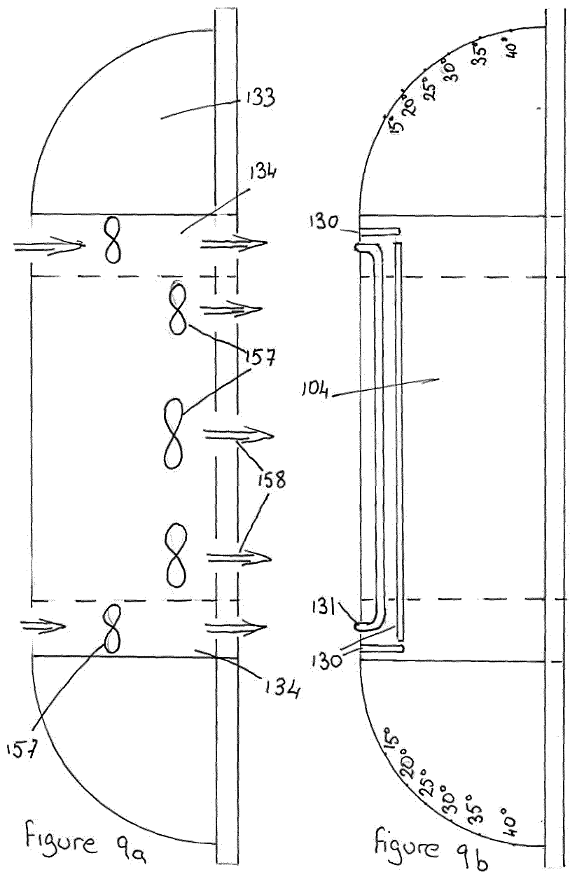

FIG. 8 shows optional membrane release button 128 for use in releasing membrane 11 manually. Optional ventilation slots 130 in front surface 111 and optional sealing ridge 131 on surface 111 are also shown in this Figure and in FIGS. 9a and 9b. These are preferably provided to assist in providing an air tight seal of membrane 11 upon surface 111.

FIGS. 9a and 9b show ventilation fans 157 installed within chamber 134 to provide the sealing of membrane 11 upon frame 100 by creating a vacuum with the use of ventilation slots 130 on surface 111 and rear ventilation slots 158 on the back of inner section 103, or on outer section 102, or both. A minimum angle of approx. 22.5 degrees is preferably used to ensure membrane 11 covers the required surface area in this embodiment.

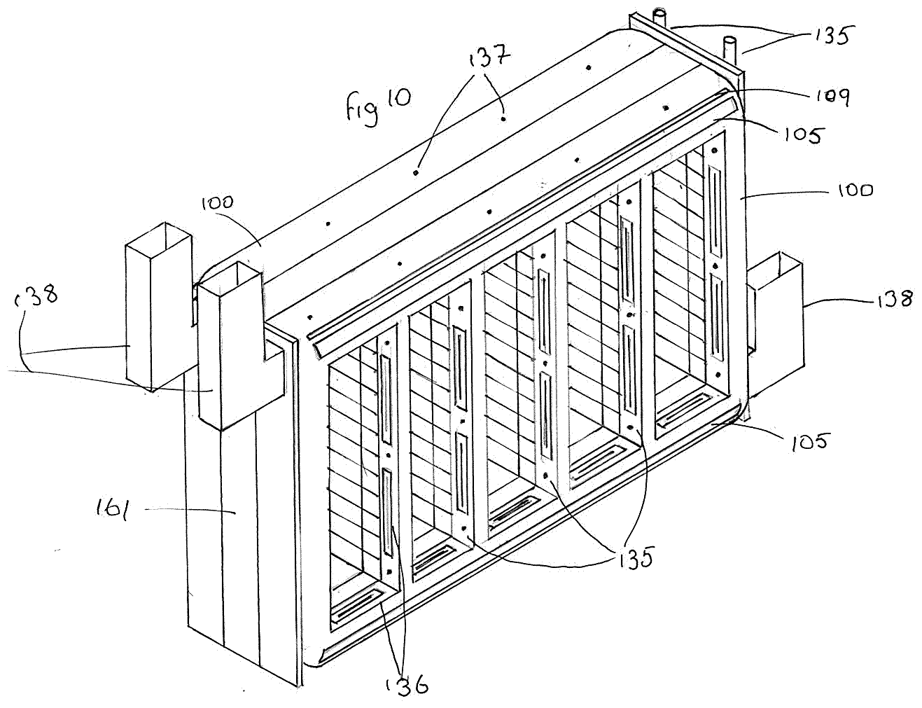

FIG. 10 shows two frames 100 in a back-to-back fashion with extension collar 161 between them. The internal structure of the frame may be used to deliver direct ventilation via vents 136, with the use of ventilation ducting 138. A fire suppression system with fire suppression pipes 135 terminated on inner opening collar wall 160 is installed in chamber 134. In this embodiment, inner opening 104 of the frame has a structure installed within to create the duct ways for the direct ventilation and a route for the fire suppression piping. Air sampling points 137 are optionally present. Extension collar 161 may be used for glanding cables or a point of termination for cabling.

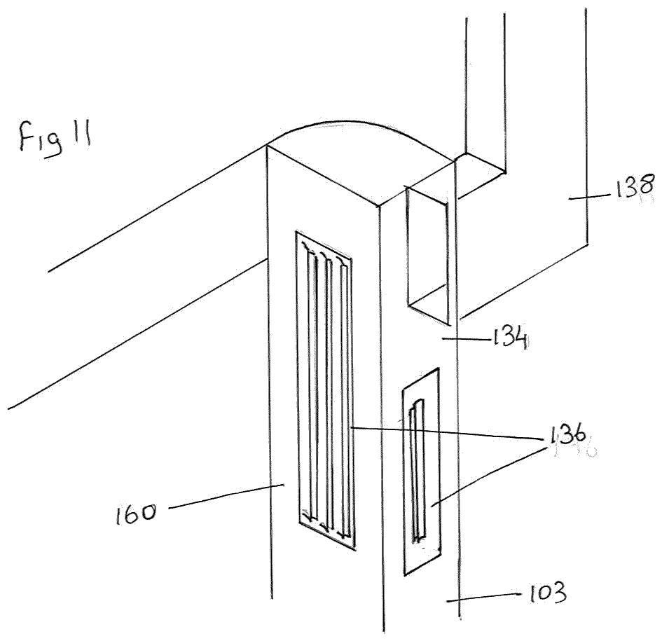

FIG. 11 shows a preferred embodiment in which a supply or extract duct of ventilation ducting 138 is connected to chamber 134. With the use of air directional vents 136 on inner collar wall 160, highly efficient ventilation may be provided. Alternatively, or additionally, air directional vents 136 are used on the rear of inner section 103.

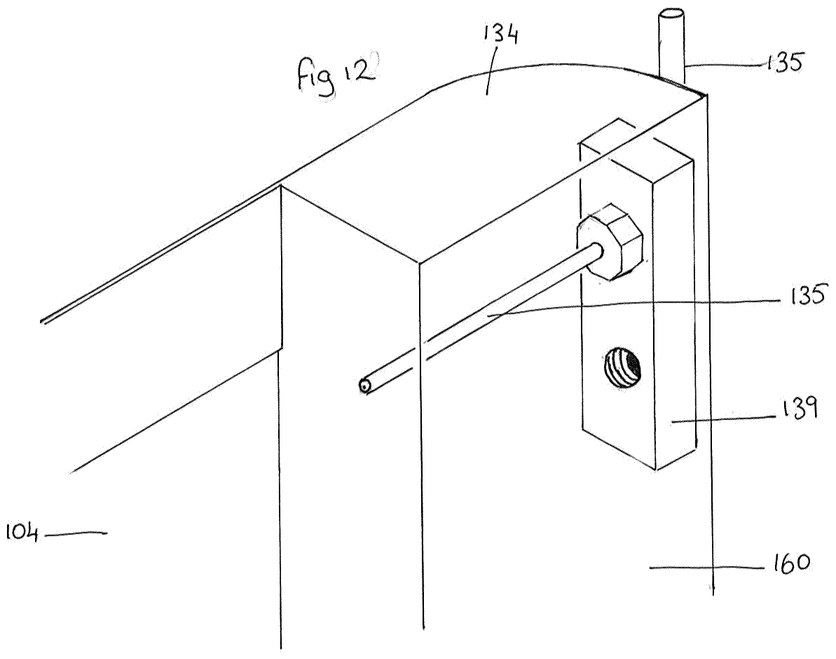

FIG. 12 shows a preferred embodiment in which fire suppression piping is terminated to fire suppression manifold 139 installed within chamber 134, with fire suppression pipe 135 installed and terminated at inner collar wall 160. Alternatively, or additionally, fire suppression points (not shown) are on the rear of inner section 103.

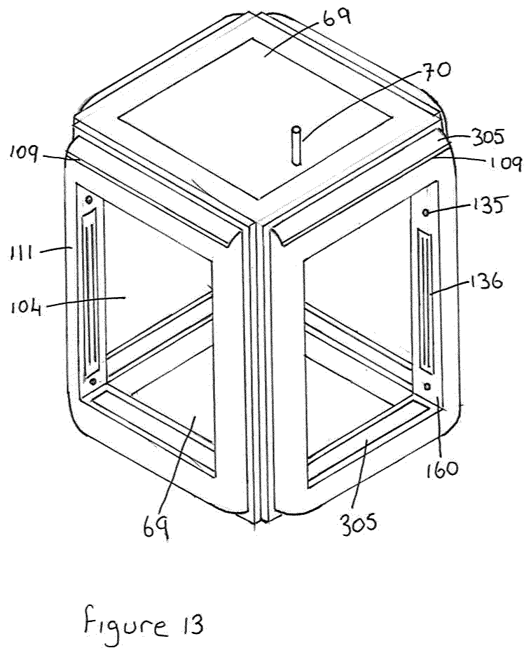

FIG. 13 shows four frames 100 connected with top and bottom plates 69 to form a cuboid shaped structure, with inner opening collar wall 160 provided with air vents 136 and fire suppression pipes 135. Access panels 305 are provided for access to internal chambers 132, 133, 134 and the services 135, 136 as well as to membrane 11 and the deployment and retrieval components. Solid top and bottom plates 69 may be used to gland cabling. In the embodiment shown in FIG. 13, optional air vent 70 is provided in top plate 69 to aid filtration.

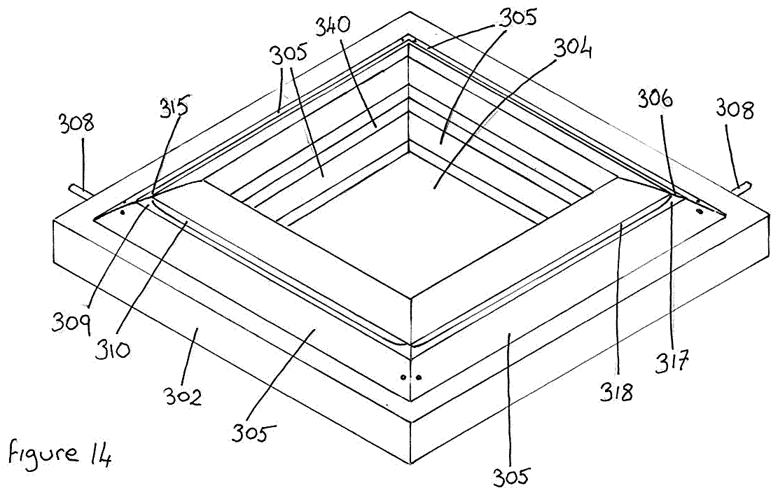

FIG. 14 shows another preferred membrane frame according to the invention, generally referred to by reference numeral 300.

Frame 300 is for two membranes, is square, and has two orthogonal slots 306, 315 for membrane deployment and two opposite orthogonal slots 309, 317 for retrieval such that the two membranes 11, 12 are orthogonal to each other once deployed. Membrane 11 is deployed via aperture 306 around a membrane guide roller (not shown) and retrieved via aperture 309 around another membrane retrieval guide roller (not shown) where it is attached to its point of actuation 308. Membrane 12 is deployed via aperture 315 around a third membrane guide roller (not shown) and retrieved via aperture 317 around a fourth membrane guide roller (not shown) where it is attached internally to its' point of actuation 308.

Loading bearing shelf 340 is attached to inner opening collar wall 360 and is provided with access panels 305 to give access to inner chamber 334. Loading bearing shelf 340 provides structure for items to rest upon or be installed on to give support for membrane 11, 12.

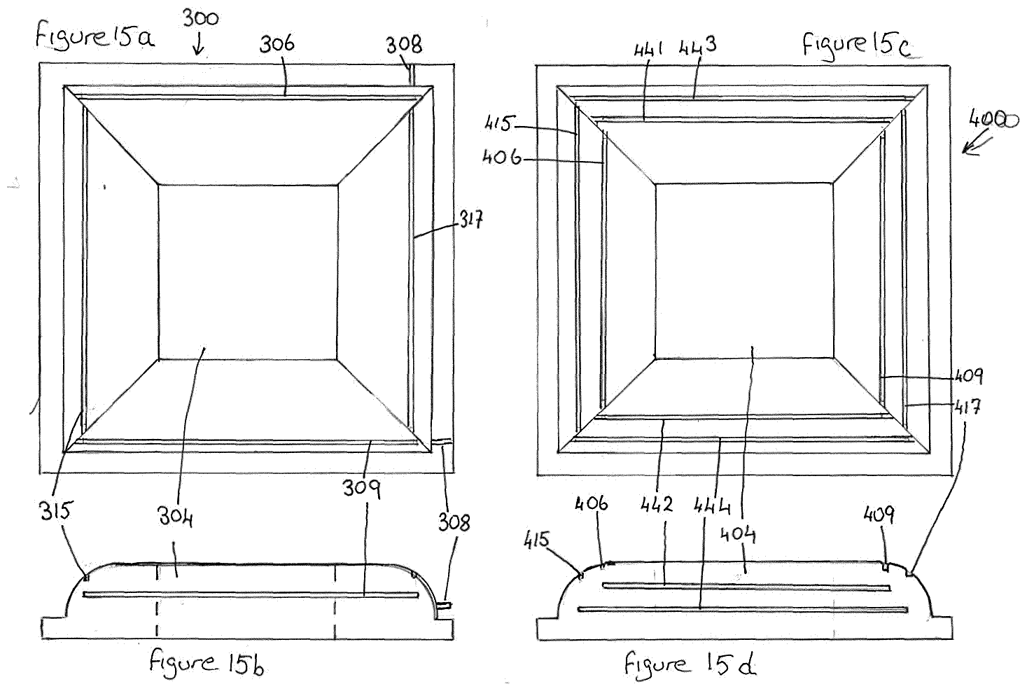

FIGS. 15a and 15b show the front and a side of frame 300, respectively. When membrane 11 is deployed from aperture 306 and retrieved in aperture 309, it covers inner frame opening 104. Membranes 11 and 12 are retrieved using actuation points 308. When membrane 12 is deployed via aperture 315 and retrieved via aperture 317 it covers inner frame opening 104 and forms a seal over the covered surface area of the frame.

FIGS. 15c and 15d show the front and a side of another preferred square membrane frame according to the invention, respectively, generally referred to by reference numeral 400. Frame 400 is for four membranes, has four slots 406, 415, 441, 443 for the deployment of four membranes where they may be retrieved dedicated aperture 409, 417, 442, 444 opposite. Membrane 11 is deployed via aperture 406 and retrieved via aperture 409.

Membrane 12 is deployed via aperture 415 and retrieved via aperture 417. Membrane 12 is deployed via aperture 415 and retrieved via aperture 417. A third membrane is deployed via aperture 441 and retrieved via aperture 442. A fourth membrane is deployed via aperture 443 and retrieved via aperture 444, with each deployed membrane covering the inner frame opening 404 and providing a sealing upon surface 411. Membranes are actuated at points 408.

Whilst frames 300 and 400 are shown as square, this is not considered to be limiting and they could be another shape, for example rectangular.

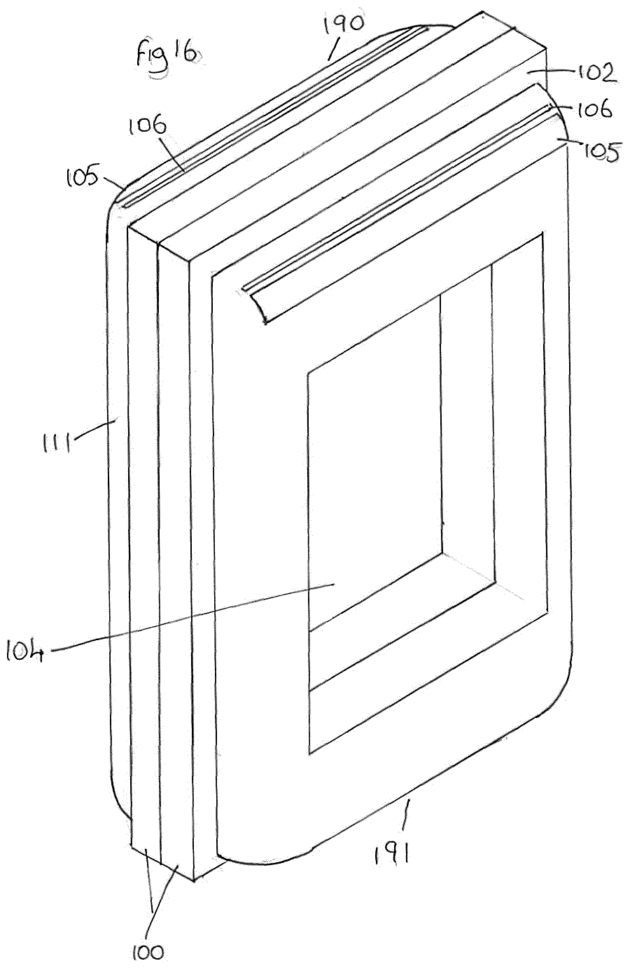

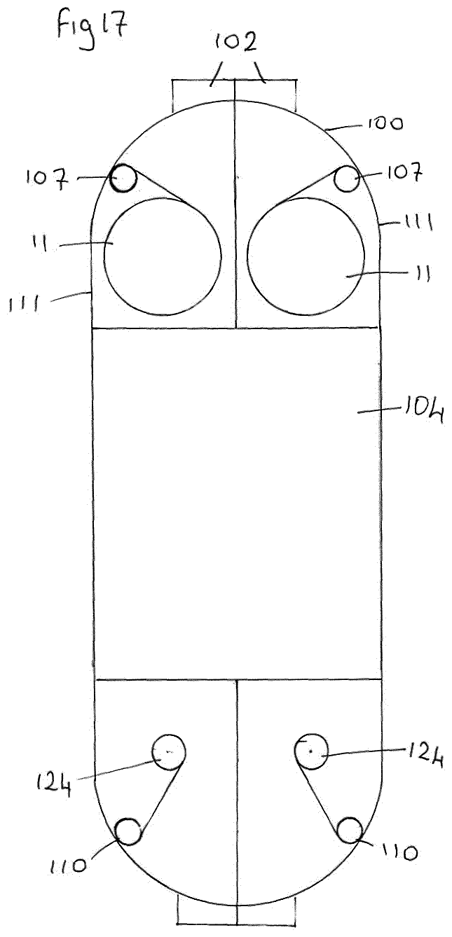

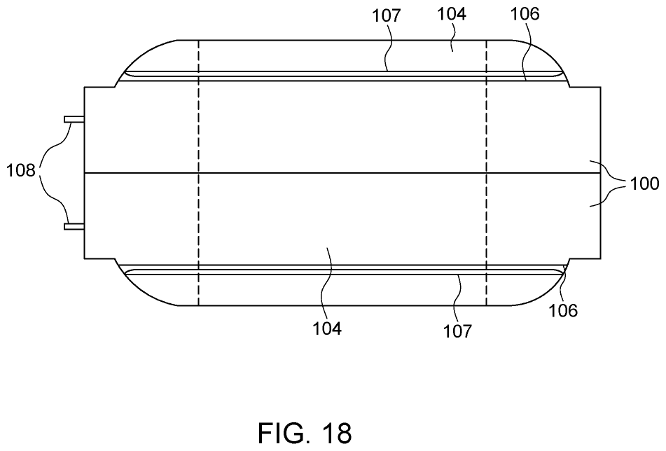

FIG. 16 shows two frames 100 according to the invention back-to-back. FIG. 17 shows an internal side view of the back-to-back frames of FIG. 16. FIG. 18 shows a plan view of the back-to-back frames of FIG. 16.

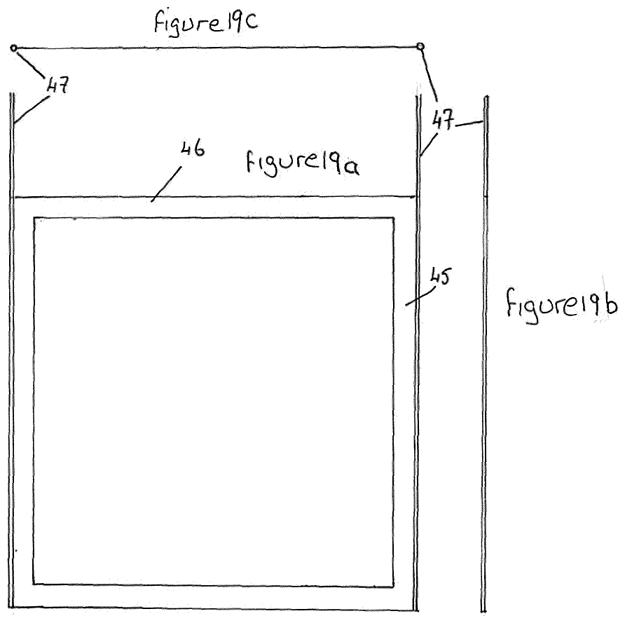

FIGS. 19a to 19c show a number of views of a preferred membrane 11 according to the invention.

Membrane 11 shown in FIGS. 19a to 19c is square in shape and comprises an impermeable surround 45 which acts an area of primary sealing upon the front surface on which it is deployed. Remaining surface area 46 of membrane 11 is preferably also impermeable and of the same composition as surround 45. Alternatively, surface area 46 is made of an alternative material or fabric suitable to its needs. The thickness of the membrane may also vary based upon what it is to be utilised for. The overall size of the membrane is governed by the inner area of the membrane housing section if it is deployed from this location. Retrieval lines 47 are embedded in the membrane.

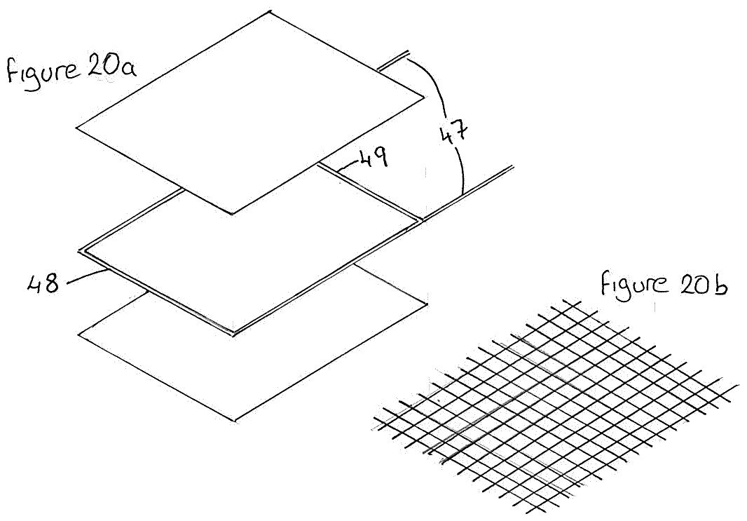

In FIGS. 20a and 20b membrane 11 is illustrated as being square in shape. However, this is not considered to be limiting and the membrane could be another shape, for example rectangular.

It can be seen from FIG. 20a that membrane 11 is multi-layered. Each layer may offer differing protection. Retention rib 48 and rigidity 49 are embedded within membrane 11.

Retention rib 48 is a strengthened or raised area on membrane 11 which assists in affixing membrane 11 to membrane retention bar 124. Rigidity 49 is also a strengthened rib that assists in retaining a deployed membrane in position.

FIG. 20b shows a preferred layer of the membrane in the form of a grid for structural integrity. The grid is preferably thin, pliable, flexible and robust.

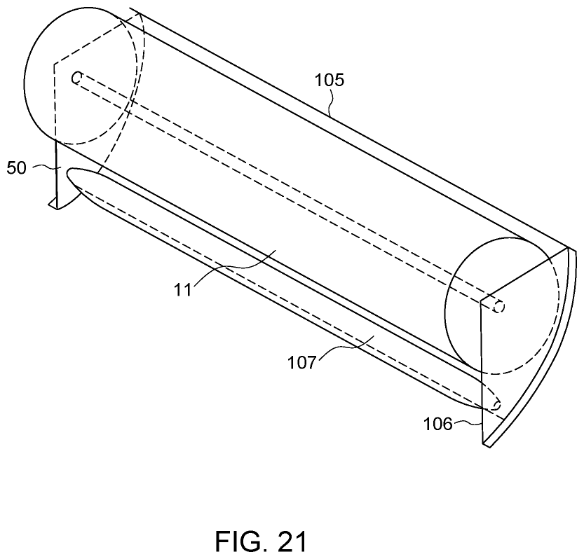

FIG. 21 shows a roll of membrane 11 located at the back of the access panel 105. The roll of membrane 11 and the membrane guide roller 107 are preferably affixed to the rear of access panel 105 using side mounting plates 50 and in doing so providing a membrane cassette design. The membrane cassette preferably has membrane guide bars (not shown) for ease of deployment. Alternatively, the cassette is independent of the cover and is enclosed installed in chamber 134 behind access panel 105.

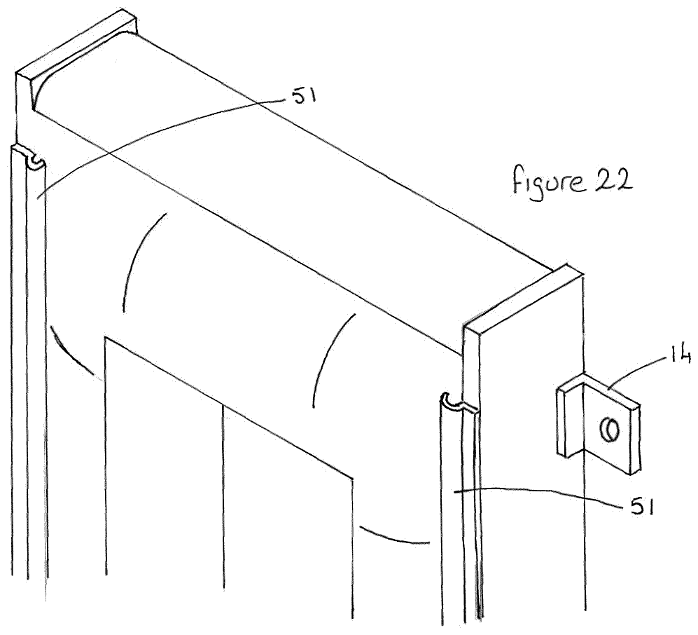

FIG. 22 shows a partial perspective view of the upper section of frame 100. Membrane 11 is preferably held in place over front surface 111 of frame 100 using retention lathes 51. Membrane 11 is then preferably manually attached at the rear of frame 100. Frame 100 is preferably fixed into position using mounting brackets 14.

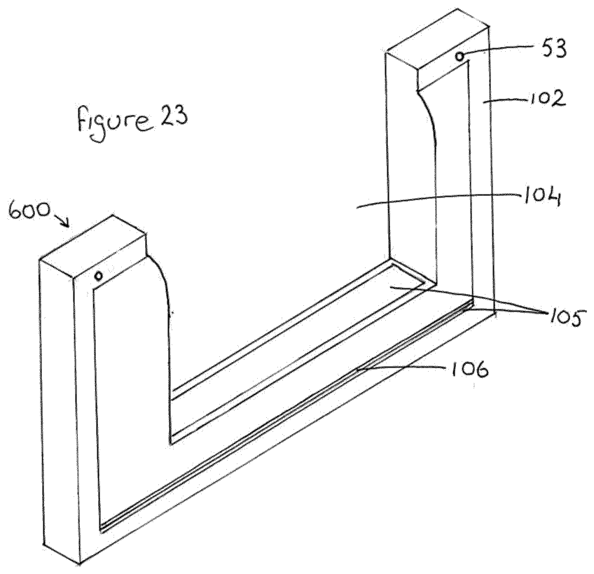

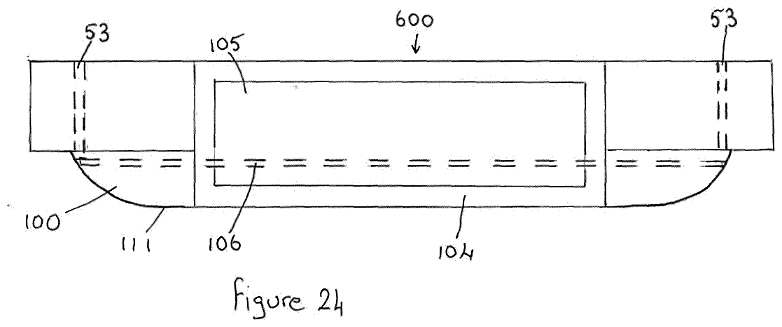

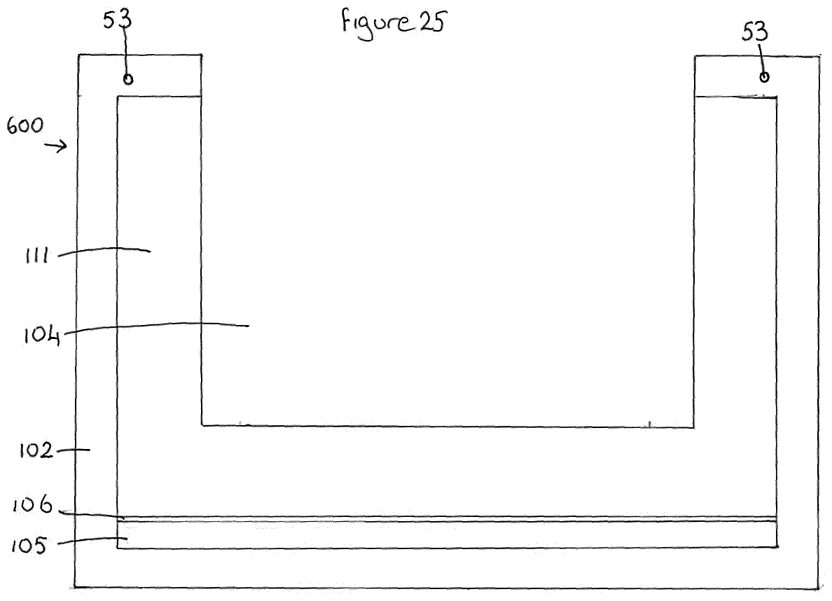

FIGS. 23, 24 and 25 show U-shaped frame 600. Once membrane 11 is housed behind access panel 105, it may be manually deployed, with membrane retrieval lines 47 being fed through the holes 53 in the frame and secured in position at the back of the frame.

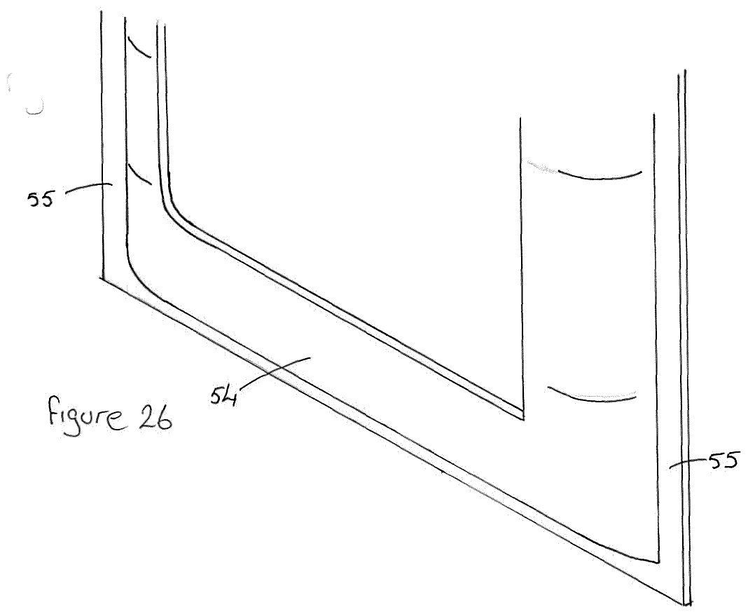

FIGS. 26 shows an optional cover 54 for the frame according to the invention. Cover 54 has wings 55 on either side to fix cover 54 to rear outer section 102.

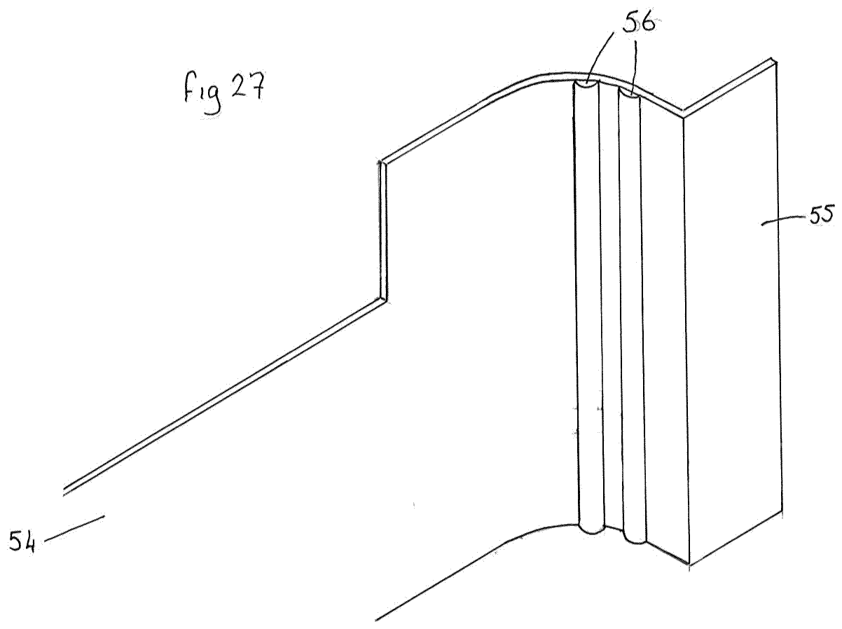

FIG. 27 shows the reverse side of cover 54 with rib feature 56 for guiding and retaining the membrane in its desired position.

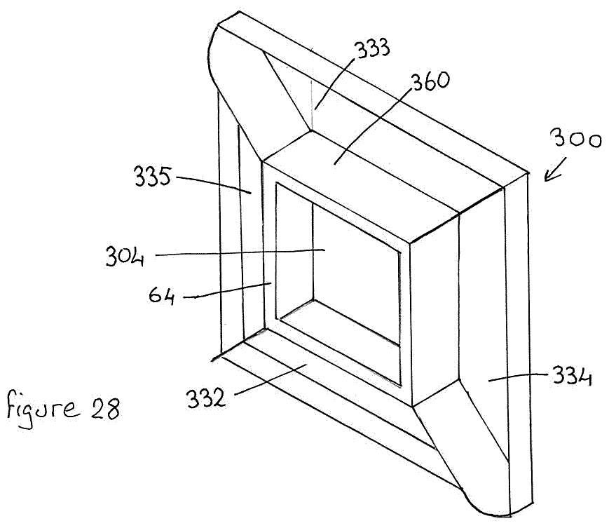

FIG. 28 shows a front view of frame 300 with front surface 111 removed. In this embodiment, inner opening 304 is surrounded by four-sided collar wall 360, with four internal chambers 332, 333, 334 and 335. Inner opening 304 has a picture frame insert 64 to provide a load bearing structure for an inwardly opening door (not shown) to rest upon.

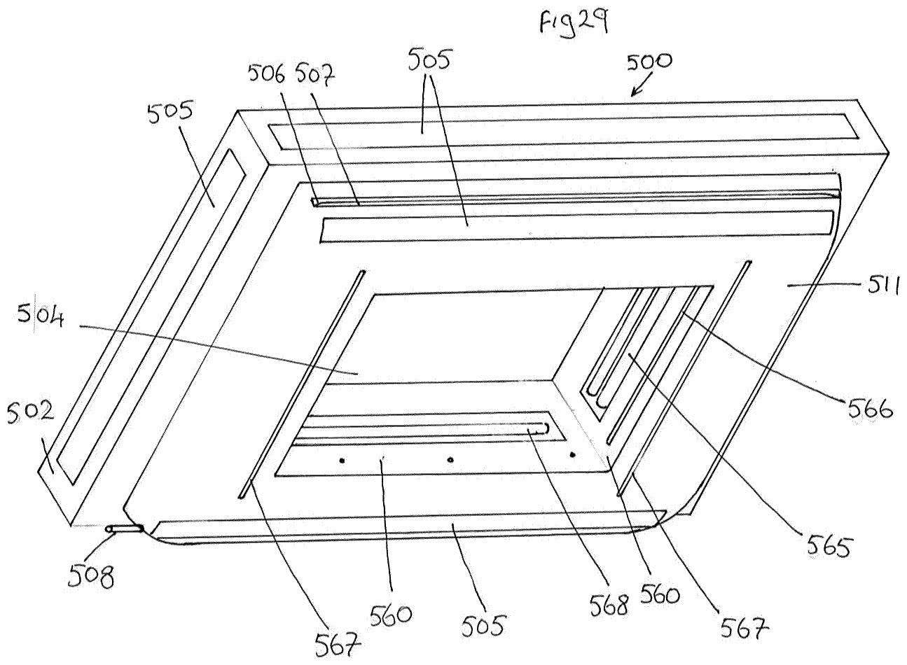

FIG. 29 shows another preferred membrane frame according to the invention, generally referred to by reference numeral 500. Frame 500 comprises access panels 505 on front surface 511 of front inner section 503 or on rear outer section 502. Membrane 11 is housed within frame 500 and deployed through aperture 506 via membrane deployment guide roller 507. Membrane 11 is retrieved at its opposite side and is actuated by rotating bar 508. Inner opening collar wall 560 is provided with fitted UV lamps 565 for water disinfectant treatment, with electrodes 566 having surface 567 and insulated from the frame, and with magnetic coils 568 which, when installed in a channel, submerged in water and energized, generate a propulsion of the water in the channel through the inner frame opening 504.

Alternatively, membrane 11 is a metallic or metallic mesh or foil which may receive an electrical current via electrodes 567 located on front surface 511.

Electrodes 566 located on front surface 511 or collar wall 560 are preferably insulated from the frame or the frame may be of an insulating property. Membrane 11 is deployed across the surface area for filtration.

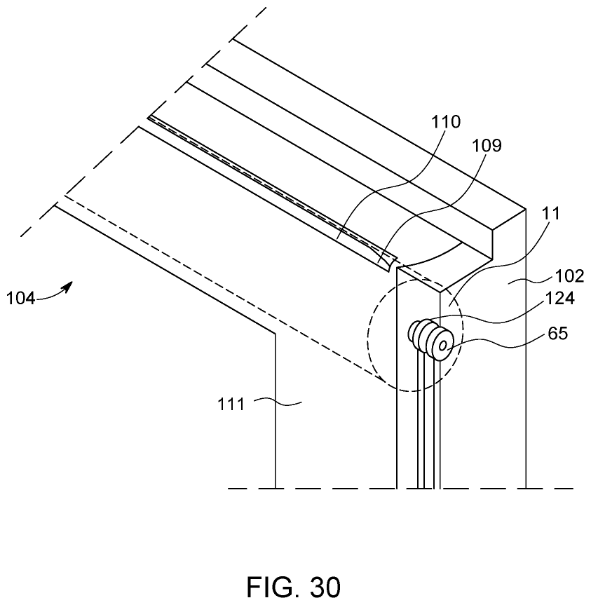

FIG. 30 shows membrane 11 retrieved via membrane retrieval aperture 109. Retrieval bar 124 is extended into outer frame 102. A mechanical linkage between the deployment and retrieval chambers can be made via the inner chamber provided by the structure 102 using a pulley wheel 65 system to promote ease of membrane retrieval.

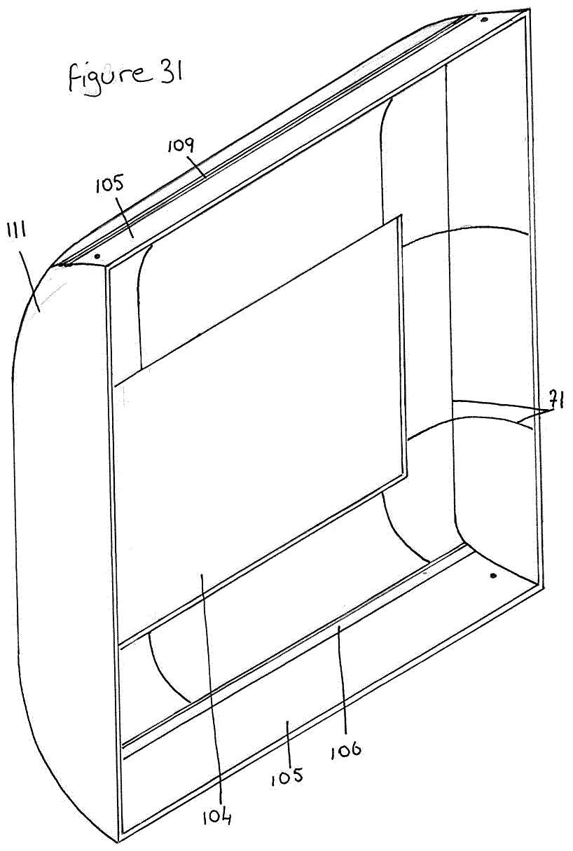

FIG. 31 shows the reverse side, i.e., interior, of skin 111. In the embodiment shown, an optional grid 71 is present for structural integrity of skin 111.

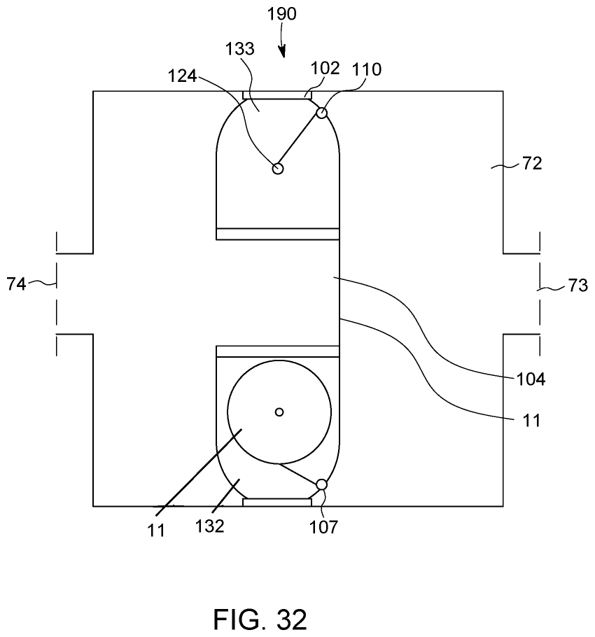

FIG. 32 shows frame 100 in the middle of an enclosure 72. In use, product for filtration enters the enclosure at opening 73 and passes through membrane 11 through the area of filtration, inner frame opening 104. The product is extracted through the enclosure point of egress 74. When the filter surface gets dirty, a new piece of membrane 11 is actuated around membrane retrieval bar 124 via membrane retrieval guide 110 in chamber 133 at end 191 from the roll or cassette of membrane 11 housed in chamber 132 via membrane deployment guide 107 at end 190 and covers inner opening 104 to give renewed filtration.

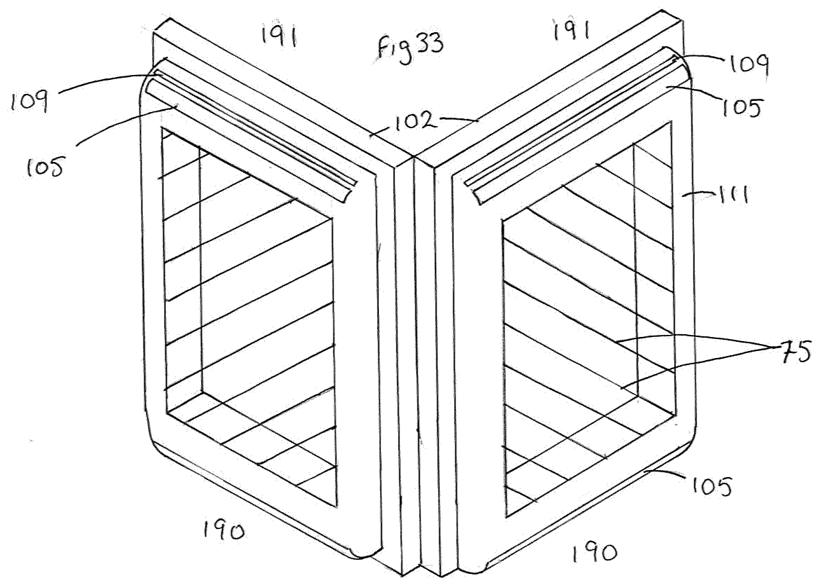

FIG. 33 shows two frames 100 according to the invention side-by-side at an angle and surrounded by structure surround 102 with a hinge pin (not shown) at each of ends 190 and 191. A load bearing mesh or grill 75 is provided within inner opening 104 to provide support for a deployed membrane. In this embodiment, the deployed membrane preferably acts as a water weir.

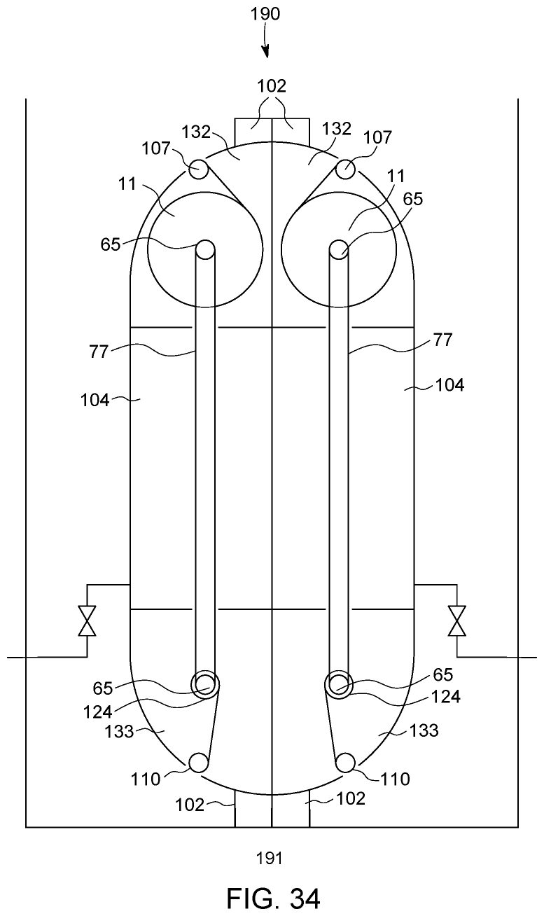

FIG. 34 shows an alternative internal side view of the back-to-back frames 100 of FIG. 16 in a tank. Outer frame structure 102 acts as standing supports for frame 100. Membrane 11 is deployed and retrieved via membrane guides 107 and 110, respectively, over inner opening 104. Mechanical linkage 77 on pully wheels 65 between deployment chamber 132 and retrieval chamber 133 assists with the deployment of membrane 11.

It is to be understood that the invention is not limited to the specific details described herein which are given by way of example only and that various modifications and alterations are possible without departing from the scope of the invention as defined in the appended claims.

1. A combination of a membrane and a frame for the membrane, wherein the membrane is housed within the frame, the frame comprising:
a rear outer section for structural integrity of the frame, wherein the rear outer section surrounds an inner frame opening;
a front inner section secured to a front of the rear outer section to form a first chamber for housing a membrane, and a section for retrieving the membrane, wherein the front inner section has a curved or angular front surface in the form of an integrally formed or separately attached skin and wherein the first chamber and the section for retrieving the membrane are at the opposite ends of the frame;
a first membrane guide located within the first chamber for use in deployment of a membrane;
wherein a first aperture from which the membrane may be deployed from the first membrane guide and a second aperture through which the membrane may be received are located at opposing ends of the front inner section such that, when deployed, the membrane covers the inner frame opening and the majority of the front surface to create a seal upon the front surface of the frame; and
wherein access panels are provided in the front inner section for access into the first chamber,
wherein the curvature or angulation of the skin of the front inner section of the frame and the resulting tightness of the membrane upon it, seals the membrane to the frame;
and wherein the membrane is of any suitable shape for deployment through the apertures and to cover the front of the frame.

2. The combination of claim 1, wherein the frame further comprises:
a second chamber for retrieving the membrane and a third chamber between the first and second chambers and surrounding the inner frame opening, wherein the first and second chambers are at the opposite ends of the frame; and
a second membrane guide within the second chamber for use in retrieval of the membrane;
wherein the second aperture through which the membrane may be received is for retrieval of the membrane onto the second membrane guide; and
wherein access panels are provided in the front inner section for access into one or more of the second and third chambers.

3. The combination of claim 2, wherein one or more walls of the third chamber comprise one or more of a ledge protruding into the inner opening of the frame, a picture frame feature upon which a door can rest, a cooling coil for use in the de-humidification of air, UV lamps for the disinfectant of water and air, electromagnetic coils and electrodes to energise and manipulate ions in water for the propulsion of water and or the conditioning of water, damper blades for the control of air velocities, and a grid or mesh for support of the membrane and which covers the area being protected or for filtration.

4. The combination of claim 2, wherein the access panels for the first and second chambers are located in the skin and the access panel for the third chamber is provided adjacent the inner frame opening.

5. The combination of claim 2, wherein the second membrane guide comprises a membrane retrieval rotating rod and a membrane retrieval guide roller located within the second chamber for use in retrieval of the membrane preferably wherein the membrane retrieval rotating rod and membrane retrieval guide roller are mechanically linked.

6. The combination of claim 2, wherein an actuator is placed on the outside of the rear outer section adjacent the second chamber or within the second chamber.

7. The combination of claim 2, wherein the frame further comprises mechanical piping installed within the third chamber and spray points on the front surface of the front inner section for use with one or more of a fire suppression or sprinkler system, a filtration area backwash or blow off system, a chemical dosing for conditioning of water or effluent, or the aeration of effluents or decontamination or humidification of air.

8. The combination of claim 2, wherein the first chamber comprises a first membrane guide roller or a first membrane guide bar, or both, and a roll or cartridge of membrane which is held in position with the use of the first membrane securing bar or rod, wherein the first membrane is pre-deployed via the first membrane guide roller and/or the first membrane guide bar and passed through the first membrane deployment aperture on the skin of the frame above the first chamber and across the surface of the frame, where it is passed through the first membrane retrieval aperture on the skin of the frame above the second chamber at the opposite side, and wherein the second chamber comprises a first membrane retrieval guide roller and/or a first membrane retrieval guide bar and a first membrane retrieval rotating bar or rod, wherein the first membrane is attached to the first membrane retrieval rotating bar or rod via the first membrane retrieval guide roller and/or the first membrane retrieval guide bar and is actuated in a clockwise or anti-clockwise direction, from a point of actuation external to the second chamber or, with the use of pulley or chain linked system from an internal point of actuation in the second chamber to further retrieve the membrane across the surface of the frame.

9. The combination of claim 1, wherein the rear outer section comprises a square or rectangular flat back plate and a box section or side perimeter walls.

10. The combination of claim 1, wherein the back of the skin is provided with rubber gaskets.

11. The combination of claim 1, wherein the first membrane guide comprises a membrane deployment bar and a membrane deployment guide roller located within the first chamber for use in deployment of the membrane, preferably wherein the membrane deployment bar and membrane deployment guide roller are mechanically linked.

12. The combination of claim 1, wherein the frame further comprises an internal frame ventilation system, such as a fan.

13. (Canceled)

14. The combination of claim 1, wherein multiple membranes are housed within the frame.

15. The combination of claim 2, wherein the frame is suitable for two membranes.

16. The combination of claim 9, wherein the front inner section and rear outer section together form five chambers, the five chambers comprising two adjacent chambers for housing a membrane and two opposing chambers for retrieving the membrane and opposing the housing chambers, with a fifth chamber located between opposing housing chambers and retrieval chambers.

17. The combination of claim 9, wherein the first chamber comprises two membrane deployment guides, one above the other, and the second chamber comprises two membrane retrieval guides, one above the other
